(19) United States
(12) Patent Application Publication
(10) Pub. No.: US 2019/0331868 A1
(43) Pub. Date: Oct. 31, 2019

(54) METHODS FOR COUPLING OPTICAL FIBERS TO OPTICAL CHIPS WITH HIGH YIELD AND LOW-LOSS

(71) Applicant: COMMSCOPE TECHNOLOGIES LLC, Hickory, NC (US)

(72) Inventors: Jan WATTÉ, Grimbergen (BE); Cristina LERMA ARCE, Gent (BE); Salvatore TUCCIO, Kessel-Lo (BE); Stefano BERI, Brussels (BE)

(73) Assignee: COMMSCOPE TECHNOLOGIES LLC, Hickory, NC (US)

(21) Appl. No.: 16/478,742

(22) PCT Filed: Jan. 17, 2018
(86) PCT No.: PCT/US2018/014096

§ 371 Date: Jul. 17, 2019

Related U.S. Application Data
(60) Provisional application No. 62/447,251, filed on Jan. 17, 2017.

(51) Int. Cl. G02B 6/44; G02B 6/42

(52) U.S. Cl. CPC G02B 6/4403; G02B 6/42; G02B 6/448

(57) ABSTRACT

An optical fiber ribbon cable is formed using thermally expandable core (TEC) fibers. Expanded optical cores are formed in sections of TEC fibers, so that each section of TEC fiber comprises a first region having an unexpanded core, a second region having an expanded core, and a tapered region between the first region and the second region. The respective sections are cleaved to length and formed into a ribbon. A hybrid optical fiber ribbon cable can be made by fusing single mode optical fibers of a single mode fiber ribbon cable with TEC fibers of a TEC fiber ribbon cable using a laser. The laser is also used to form tapered core regions in the TEC fibers to reduce coupling losses between the TEC fibers and the single mode fibers.

### CROSS-REFERENCE TO RELATED APPLICATION

This application is being filed on Jan. 17, 2018 as a PCT International Patent Application and claims the benefit of U.S. Patent Application Ser. No. 62/447,251, filed on Jan. 17, 2017, the disclosure of which is incorporated herein by reference in its entirety.

### BACKGROUND OF THE INVENTION

The present invention is generally directed to optical communications, and more specifically to methods of coupling optical fibers to optical chips.

Optical communications systems are becoming more reliant on the use of optical chips for performing various functions on optical signals, such as switching, attenuating, multiplexing, demultiplexing, etc. Optical chips typically contain one or more input waveguides that input the light signal from an external source, one or more output waveguides that output an optical signal, and various optical devices that are connected via the input and output waveguides and, in some case, by other connecting waveguides. An advantage of optical chip technology is that a number of different optical channels can be controlled by the same chip.

Optical chips can be fabricated on any type of substrate that is transparent to the wavelength of the light being controlled on the chip. Silica glass and silicon, for example silicon implemented as silicon-on-insulator (SOI), have been used.

As integrated photonics devices become more mature, attention is being directed to reducing optical losses in optical data systems, such as coupling losses experienced between an optical fiber network and an optical chip. Such losses can be due, at least in part, to mismatches between the mode of the optical fiber that delivers the optical signal to the optical chip and the waveguides of the optical chip itself. For example, in many optical data systems, optical signals are carried in single mode silica glass fibers (SMFs) that have a mode diameter of around 9 μm. The mode size of a single mode waveguide at the input/output of an SOI chip, on the other hand, is around 4 μm. As a result, significant optical losses can occur where there is no mode conversion when coupling between an SMF and an optical chip.

There is a need, therefore, to develop approaches for low-loss coupling between optical fibers and optical chips. In particular, there is a need to develop approaches for low-loss coupling in parallel situations where there are several fibers coupled to a chip.

### SUMMARY OF THE INVENTION

One embodiment of the invention is directed to an optical fiber ribbon cable that has a plurality of thermally expandable core (TEC) optical fibers formed in a ribbon. Each TEC optical fiber has a first end, a second end couplable to another optical fiber and an optical core extending between the first end and the second end. The optical core of each TEC optical fiber has a first diameter at the first end and a second diameter at the second end, the second diameter being larger than the first diameter. The optical core of each TEC optical fiber includes a tapered core section at a region of the optical core between the first end and the second end.

Another embodiment of the invention is directed to a method of forming an optical fiber ribbon cable. The method includes thermally forming expanded optical cores in a plurality of respective sections of thermally expandable core (TEC) fibers, so that each section of TEC fiber comprises a first region having an unexpanded core, a second region having an expanded core, and a tapered region between the first region and the second region. The method also includes cleaving the respective sections of the TEC fibers and forming the sections of the TEC fibers having the expanded optical cores into a ribbon.

Another embodiment of the invention is directed to a method of forming a hybrid optical fiber ribbon cable. The method includes providing a first fiber ribbon cable comprising single mode optical fibers, the single mode optical fibers having ends, and providing a second fiber ribbon cable comprising thermally expandable core (TEC) optical fibers, the TEC optical fibers having ends. The method also includes fusing the ends of the single mode fibers to the ends of respective TEC fibers using laser radiation. A tapered core region is formed in the TEC fibers, proximate the ends of the TEC fibers, using laser radiation.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates a prior art approach to coupling a single SMF to an optical chip;

FIG. 2A schematically illustrates heating of a TEC fiber according to an embodiment of the present invention;

FIG. 2B schematically illustrates the formation of an expanded core in a TEC fiber section according to an embodiment of the present invention;

FIG. 2C schematically illustrates formation of a separate section of TEC fiber having an expanded core, according to an embodiment of the present invention;

FIG. 2D schematically illustrates a ribbonized fiber cable comprising separate sections of TEC fiber having expanded cores, according to an embodiment of the present invention;

FIG. 2E schematically illustrates an end view of an alignment block with attached TEC fibers for coupling to an optical chip, according to an embodiment of the invention;

FIG. 2F schematically illustrates an embodiment of a TEC fiber ribbon cable spliced to an SMF ribbon cable, according to an embodiment of the invention;

FIG. 3 schematically illustrates heating of a TEC fiber using a laser to form an expanded core in the TEC fiber;

FIGS. 4A And 4B schematically illustrate the use of laser radiation to fuse a TEC fiber with a single mode fiber and to form an expanded core section in the TEC fiber, according to an embodiment of the present invention;

FIG. 5 schematically illustrates the use of laser radiation to fuse TEC fibers in a TEC fiber ribbon with single mode fibers of a single mode fiber ribbon and to form expanded core sections in the TEC fibers, according to an embodiment of the present invention;

FIG. 6 schematically illustrates an experimental set-up for measuring optical losses in splices, as used in Example 1;

FIGS. 7A and 7B graphically present results of optical loss measurements for splices made using the process described in Example 1; and

FIG. 8 graphically presents results of optical loss measurements for splices made using the process described in Example 2.

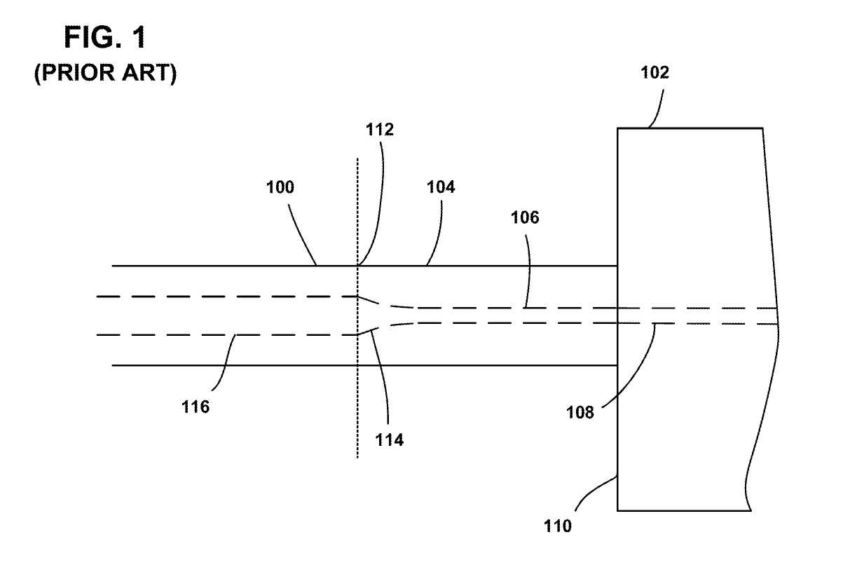

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is directed to systems, devices, and methods that can provide benefits to optical communication networks.

One method for providing a low-loss coupling between one SMF 100 and an optical chip 102 includes the use of a short length of fiber 104 having a thermally expandable core (TEC), hereafter referred to as TEC fiber. The TEC fiber 104 is formed with a core 106 having a dimension that closely matches that of the chip waveguide 108, so that there is good coupling between the TEC fiber core 106 and the chip waveguide 108 when the TEC fiber 104 is butted against the input surface 110 of the chip. The SMF 100 and the TEC fiber 102 may be aligned to the chip 102 via any suitable means, for example using a v-groove alignment mechanism or via core camera alignment (not shown).

The SMF 100 is fusion spliced to the TEC fiber 104 at the fusion region 112 to form a hybrid fiber, i.e. a fiber that is part TEC fiber and part non-TEC fiber. Exposure of the TEC fiber core 106 to heat during the fusion splicing process results in an expansion of the TEC fiber core 106 to form a tapered core region 114 that is more closely matched to the dimension of the SMF core 116. The expansion of the TEC fiber core 106 when heated is a result of thermally-enhanced diffusion of species that provide a high refractive index, for example metal ions, such as transition metal ions. The plasma arc is applied to the fusion joint for a duration that is longer than normal for fusion splicing, in order to provide sufficient heating for the core to thermally expand. Whereas normal fusion splicing requires exposure to the plasma arc for a fraction of a second, the tapered TEC core region 112 results after exposure to the plasma arc for several seconds, typically in the range 10 s-20 s. The axial extent of the tapered core region 114 is close to the width of the plasma arc exposed to the TEC fiber 104 during the plasma fusion process. Examples of TEC fiber currently available include the high numerical aperture UHNA series of fibers available from Nufern Inc., East Granby, Conn.

The scaling of this approach to multi-fiber applications has, unfortunately, been found to be problematic. Modern multi-fiber applications tend to use ribbonized fibers for ease of handling, where fibers are formed into a single ribbon using a ribbonizing tool. For example, a ribbonized fiber may include four or eight, or some other number of optical fibers. Ribbon splicers, such as the FSM-series of ribbon splicers available from Fujikura, Tokyo, Japan, are commonly used for splicing ribbonized fibers together. It has been found, however, that plasma splicing an SFM ribbon to a ribbon of TEC fibers does not consistently produce low loss fiber splices. SMF ribbon to SMF ribbon splicing is well known, and can be achieved with low optical loss. For example, ribbon splicing a 4-fiber SMF ribbon to a second 4-fiber SMF ribbon using a plasma ribbon splicer (Furukawa FSM-30R), results in fiber splice losses of the order of 0.01-0.02 dB across the ribbon. Plasma fusion of a 4-fiber SMF ribbon to a 4-fiber TEC ribbon (UHNA4 fiber), on the other hand, results in higher losses and less consistent loss across the width of the fiber, ranging from 0.07 dB to 0.29 dB in different fibers, even after optimization of the plasma conditions. Splice losses across an 8-fiber SMF ribbon fused to an 8-fiber TEC fiber ribbon (UHNA4 fiber) also resulted in inconsistent splice losses across the ribbon, regardless of splicer settings: splice losses ranged from 0.13 dB to 0.85 dB across the spliced ribbon. The UHNA4 TEC fibers used in these experiments were obtained from Nufern, East Granby, Conn.

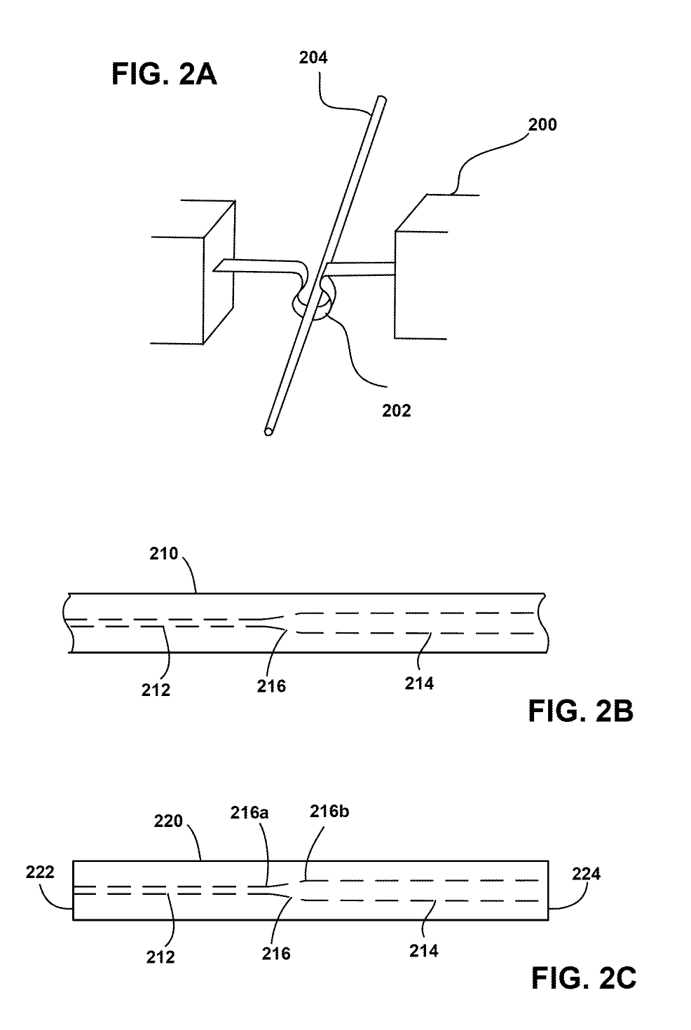

Thus, the present invention is directed to methods of making ribbonized hybrid fibers that avoid the problem of high splice loss and inconsistent splice losses across the ribbon. One approach is to first form lengths of TEC fiber having an expanded core. One way of doing this is to heat a length of TEC fiber, for example in a filament heater, as shown in FIG. 2A. The filament heater 200 includes a filament 202 that substantially surrounds a length of TEC fiber 204. By selectively heating along the axis of the TEC fiber 204, a core can be engineered in the TEC fiber 204 having a desired profile. For example, a cross-section through a TEC fiber 210 having an expanded core is schematically illustrated in FIG. 2B. A section of the TEC fiber 210, that was not heat treated, has a core 212 with a small diameter. A section of the TEC fiber 210, that was heat treated, has a core 214 that is expanded to a diameter suitable for coupling to an SMF. A tapered core region 216, that was subject to an axially varying amount of heat treatment, forms a transition between the treated section and the untreated section of the TEC fiber 210. The tapered core region 216 has a narrow end 216a, where the core width is relatively narrow, and a wide end 216b, where the core width is relatively wider than the narrow end 216a. Thus, unlike the tapered core region 114 that was formed during a plasma fusion splice step, the tapered core region 216 is not created during the formation of a fusion splice. It will be appreciated that the fiber 210 shown in FIG. 2B, and subsequent figures schematically illustrating fibers are not necessarily drawn to scale.

Lengths of the expanded core TEC fiber 220 may be cut, e.g. through cleaving to form ends 222 and 224, as shown in FIG. 2C. The cutting to length may take place before or after the lengths of fiber are heated to form an expanded core. Multiple lengths of expanded core TEC fiber 220 may then be ribbonized. An illustrated embodiment of a fiber ribbon in FIG. 2D shows a fiber ribbon 230 that contains four expanded core fibers 220, although a fiber ribbon may contain a different number of fibers. At a first end 232 of the ribbon 230, where the fiber cores are not expanded, the fiber ends 234 may be set in an alignment block 236 for subsequent alignment with an optical chip. FIG. 2E schematically illustrates an end view of the alignment block 236 showing the fiber ends 234 aligned in V-grooves 242.

At the second end 238 of the ribbon 230, where the fiber cores are expanded, the fiber ends 240 are exposed. Thus, the ribbon 230 includes a number of fibers 220 whose cores have relatively small diameter at the first end 232 and relatively large diameters at the second end 234. The exposed fiber ends 240 may subsequently be fusion spliced to a ribbon 250 of single-mode fibers 252, as is schematically illustrated in FIG. 2F. Splicing between the TEC fiber ribbon 230 and the SMF ribbon 250 may be performed via plasma fusion splicing using conventional fusion splicing parameters, i.e. exposure to the plasma arc for a fraction of a second rather than for many seconds. In this manner, an expanded core fiber can be obtained using a high-yield, short arc duration method, rather than the lower-yield, long arc duration method that is required if the TEC fiber core is being tapered at the same time as it is being fusion spliced.

Steps for the process of making a ribbonized fiber cable for that contains expanded-core TEC fibers include thermally forming expanded optical cores in a number of respective sections of TEC fibers, so that each section of TEC fiber comprises a first region having an unexpanded core 212, a second region having an expanded core 214, and a tapered core region 216 between the first and second regions. The respective sections of the TEC fibers can be cleaved to a desired length either before or after the fiber cores are thermally expanded. The sections of the TEC fibers having the expanded optical cores can then be formed into a ribbon using conventional ribbonizing techniques.

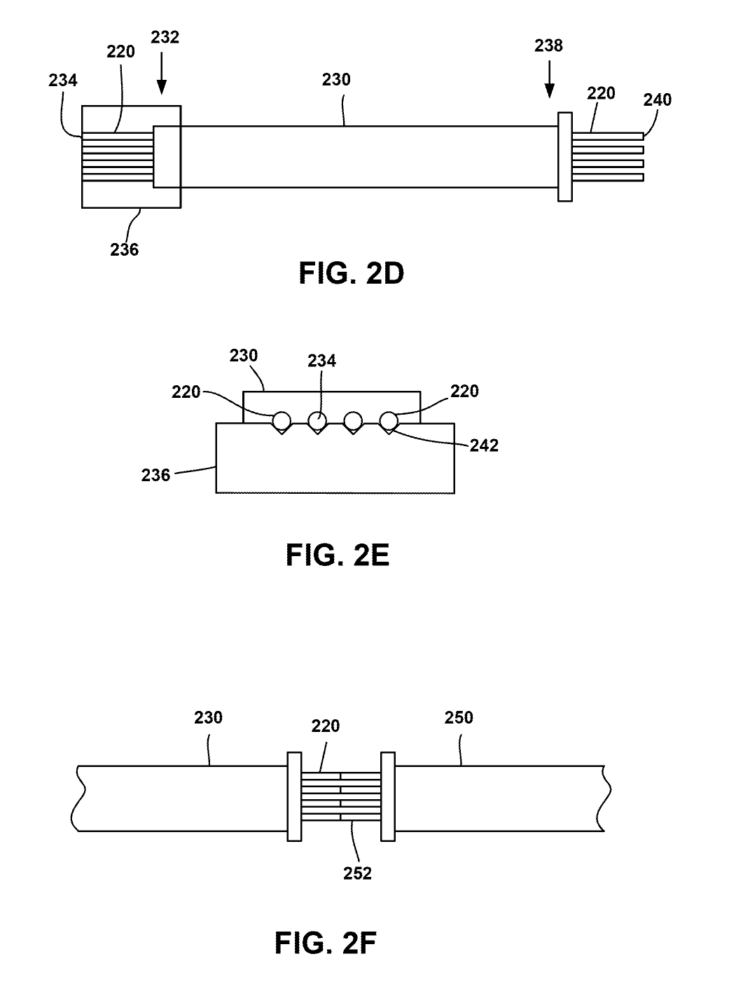

In addition to using a filament for heating the TEC fiber core, another method of selectively heating a section of TEC fiber to expand the TEC fiber core is to use a laser, for example a carbon dioxide (CO₂) laser. It is important that, for laser heating, the wavelength of light produced by the laser is absorbed by the optical fiber. The CO₂ laser typically produces radiation at 10.6 μm, which is absorbed in silica glass. An exemplary set up for laser heating a TEC fiber 304 is schematically illustrated in FIG. 3. In this embodiment, a laser source 300, such as a CO₂ laser directs a beam of radiation 302 onto the TEC fiber 304. The TEC fiber 304 may be moved axially, in the directions shown by the two-headed arrow, to selectively heat different portions of the TEC fiber 304. In another embodiment, the radiation beam 302 may be redirected so as to move along the length of the TEC fiber 304 for selective axial heating of the fiber 304.

As with the method of filament heating discussed above, the TEC fiber 304 may be cut into sections of desired length either before or after the formation of an expanded core.

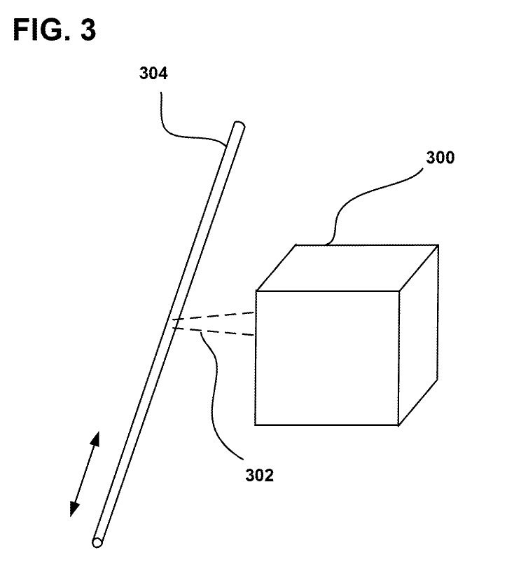

FIGS. 4A and 4B schematically illustrate an approach to fusing a TEC fiber with a single mode fiber using a laser, where the laser is also used to expand the core of the TEC fiber. The end 404 of a single mode fiber 400, having a core 402, is butted against the end 414 of a TEC fiber 410 that has a core 412. The radiation beam 408 from the laser is directed to the region where the two ends 404, 414 are butted together: heating in this region softens the glass of each fiber 400, 410, permitting fusion splicing to occur. The radiation beam 408 can also be directed along the TEC fiber 410, in a direction away from the single mode fiber 400, so as to selectively heat the portion of the TEC fiber core 412 that is closest to the splice and thus expand the core 412 to form a tapered core region 416 that couples between the relatively wide single mode fiber core 402 and the relatively narrow TEC fiber core 412.

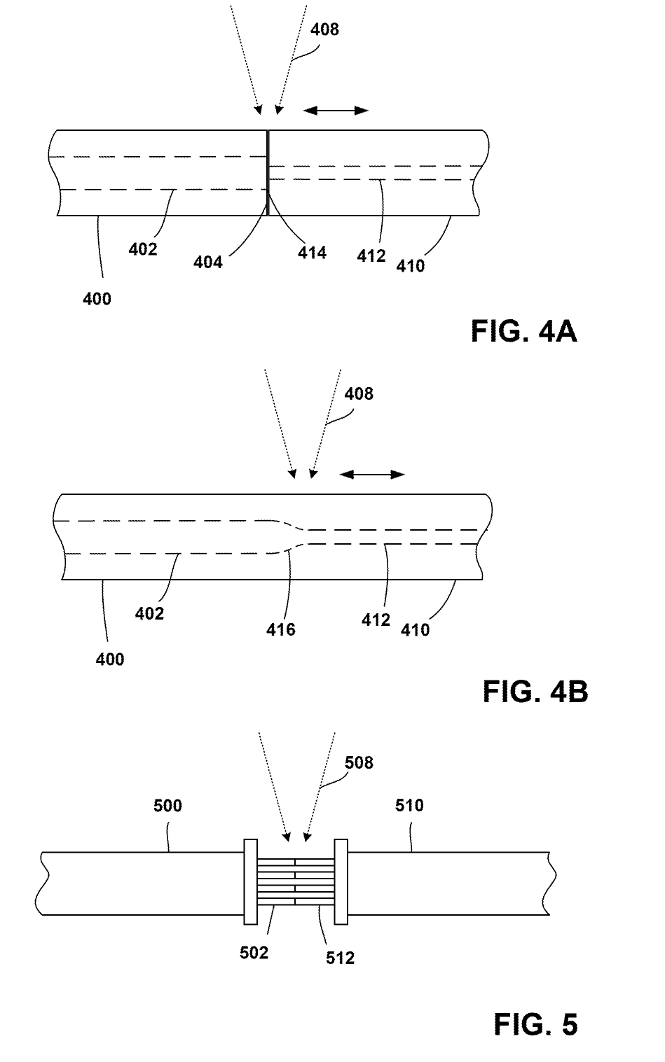

Since the laser fusion/thermal core expansion technique works provides more uniform, low splice loss across a fiber ribbon than does plasma arc splicing, the use of a laser to fuse the fibers while simultaneously expanding the core of the TEC fiber can allow for efficient splicing of a TEC fiber ribbon cable to an SMF ribbon cable. For example, in the exemplary embodiment illustrated in FIG. 5, an SMF ribbon cable 500, containing a number of single-mode fibers 502, and a TEC fiber ribbon cable 510, containing a number of TEC fibers 512, can be spliced together using laser radiation 508 in a manner like that described above for FIGS. 4A and 4B. The laser radiation 508 can be used to splice a single-mode fiber 502 of the SMF ribbon cable 500 to a TEC fiber 512 of the TEC fiber ribbon cable 510 and, in the same operation, form an expanded core region in the TEC fiber 512 provide low loss coupling between the relatively large diameter core of the single mode fiber 502 and the relatively small diameter fiber core of the TEC fiber 510.

Results of two different approaches to using a CO₂ laser to expand the core of a TEC fiber, and for splicing an expanded core TEC fiber to a single mode fiber, are presented.

### Example 1

The process included the steps of thermal core expansion followed by splicing. Thermal core expansion was based on illuminating the fiber multiple times with a CO₂ laser (Lazermaster CO₂, produced by AFL, Duncan, S.C.) with sufficient cool down time between illumination pulses that cladding deformation was avoided. The ends of a 1 m length of UHNA4 TEC fiber were illuminated with either 30 cycles of the CO₂ laser on for 2 sec and off for 3 sec, or 6 cycles of the laser on for 6 sec and off for 9 sec.

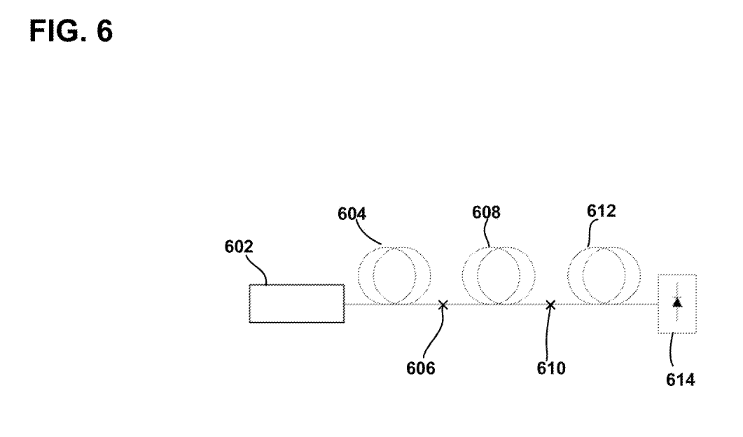

The TEC fiber was spliced in between two single mode SMF-28 patch cords, each 5 m long, using a set up as shown in FIG. 6. A tunable amplified spontaneous emission (ASE) source 602 was coupled to the first SMF-28 single mode fiber patch cord 604. A first splice 606 was formed using the CO₂ laser between the first patch cord 604 and the TEC fiber 608. A second splice 610 was formed using the CO₂ laser between the TEC fiber 608 and the second patch cord 612. The optical output from the second patch cord 612 was directed to a power meter 614 (Newport Model No. 2835C with 818-IR detector). The splice losses were measured using V-groove block array splicing, using a CO₂ laser SMF-28 to SMF-28 splice as a reference.

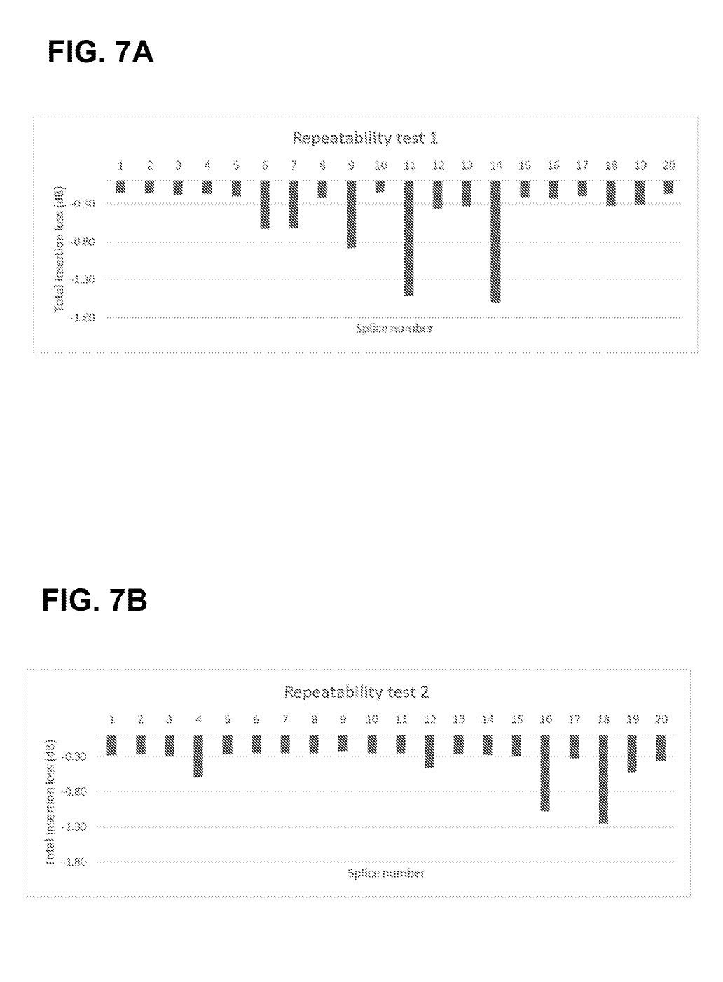

A number of SMF-28 to TEC fiber to SMF-28 splices were made and their losses measured for repeatability. The losses measured for a first set of 20 splices are shown in FIG. 7A and the losses measured for a second set of 20 splices are shown in FIG. 7B. The measured losses are for light passing through two SMF-28 to TEC fiber splices. While many of the measurements showed losses of 0.3 dB or less, a handful of splices shows considerably greater loss, up to around 1.5 dB.

Typical losses in dB, as a function of wavelength, are shown in the following table.

| Description | 1310 nm | 1550 nm | 1625 nm |
|---|---|---|---|
| Splice 1 | 0.26 | 0.15 | 0.15 |
| Splice 2 | 0.42 | 0.36 | 0.41 |
| Splice 3 | 0.37 | 0.23 | 0.23 |

### Example 2

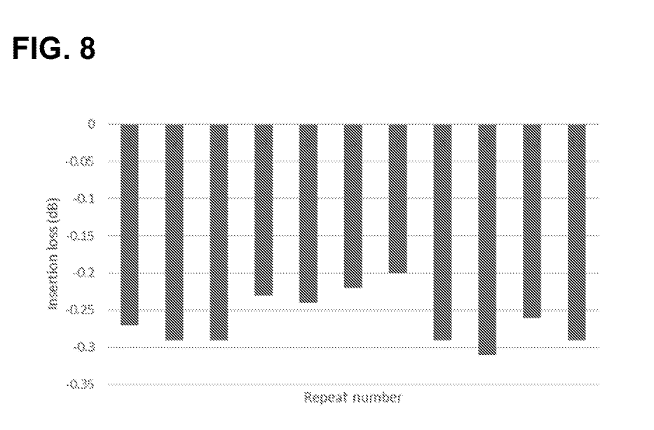

The process used in Example 2 was to thermally expand the core of a 1 m length of UHNA4 TEC fiber over a long section. The TEC fiber was then cleaved in the center of the thermally expanded core area using a conventional fiber cleaver. A CO₂ laser was used to splice the cleaved TEC fiber to an SMF-28 fiber using the same settings as are used for SMF-28 to SMF-28 splicing. FIG. 8 shows the measured losses (doubled, to allow a comparison with the results of Example 1).

Typical losses in dB, as a function of wavelength, are shown in the following table.

| Description | 1310 nm | 1550 nm | 1625 nm |
|---|---|---|---|
| Splice 1 | 0.1 | 0.09 | 0.15 |
| Splice 2 | 0.19 | 0.17 | 0.23 |
| Splice 3 | 0.17 | 0.19 | 0.23 |

The splice losses obtained using this technique were generally less than those achieved using the technique of Example 1, typically in the range 0.1-0.15 dB per splice. Furthermore, the variation in splice loss across multiple splices was less. These experiments show that a CO₂ laser may be used form expanded core section in TEC fiber and to form low loss hybrid splices between an expanded core TEC fiber and a single mode fiber.

Various modifications, equivalent processes, as well as numerous structures to which the present invention may be applicable will be readily apparent to those of skill in the art to which the present invention is directed upon review of the present specification. The claims are intended to cover such modifications and devices. For example, in the examples discussed above, each fiber ribbon cable contains only four fibers, although a fiber ribbon cable according to the invention may contain a different number of fibers, for example 8 or 16 fibers.

As noted above, the present invention is applicable to optical systems for communication and data transmission. Accordingly, the present invention should not be considered limited to the particular examples described above, but rather should be understood to cover all aspects of the invention as fairly set out in the attached claims.

What we claim as the invention is:

1. An optical fiber ribbon cable comprising:
a plurality of thermally expandable core (TEC) optical fibers formed in a ribbon, each TEC optical fiber comprising a first end, a second end couplable to another optical fiber, and an optical core extending between the first end and the second end;
wherein the optical core of each TEC optical fiber has a first diameter at the first end and a second diameter at the second end, the second diameter being larger than the first diameter; and
wherein the optical core of each TEC optical fiber includes a tapered core section having a wide end between the first end and the second end of the TEC optical fiber.

2. An optical fiber ribbon cable as recited in claim 1, further comprising an alignment block, the first ends of the optical fibers being attached to the alignment block.

3. An optical fiber ribbon cable as recited in claim 2, wherein the alignment block further comprises V-grooves and the first ends of the TEC optical fibers are attached in the V-grooves of the alignment block.

4. A method of forming an optical fiber ribbon cable, comprising
thermally forming expanded optical cores in a plurality of respective sections of thermally expandable core (TEC) fibers, so that each section of TEC fiber comprises a first region having an unexpanded core, a second region having an expanded core, and a tapered region between the first region and the second region;
cleaving the respective sections of the TEC fibers; and
forming the sections of the TEC fibers having the expanded optical cores into a ribbon.

5. A method as recited in claim 4, wherein the respective sections of the TEC fibers are cleaved before thermally forming the expanded optical cores in the plurality of the respective sections of the TEC fibers.

6. A method as recited in claim 4, wherein the respective sections of the TEC fibers are cleaved after thermally forming the expanded optical cores in the plurality of the respective sections of the TEC fibers.

7. A method as recited in claim 4, wherein thermally forming the expanded optical cores in the plurality of respective sections of TEC fibers comprises heating selected portions of the respective sections of TEC fibers using a filament.

8. A method as recited in claim 4, wherein thermally forming the expanded optical cores in the plurality of respective sections of TEC fibers comprises heating selected portions of the respective sections of TEC fibers using a laser.

9. A method as recited in claim 8, wherein the laser is a carbon dioxide laser.

10. A method as recited in claim 4, further comprising attaching first ends of the sections of TEC fibers having unexpanded optical cores to an alignment block.

11. A method as recited in claim 10, further comprising aligning the alignment block with an optical chip so that the unexpanded cores of the sections of TEC fibers are aligned with waveguides in the optical chip.

12. A method as recited in claim 4, further comprising attaching second ends of the sections of TEC fibers having expanded optical cores to ends of respective single mode fibers.

13. A method as recited in claim 12, wherein the respective single mode fibers are formed in a single mode fiber ribbon cable.

14. A method as recited in claim 12, wherein attaching the second ends of the sections of TEC fibers to the ends of the respective single mode fibers comprises fusion splicing the second ends of the TEC fibers to the ends of the respective single mode fibers using a plasma arc.

15. A method of forming a hybrid optical fiber ribbon cable, comprising:
providing a first fiber ribbon cable comprising single mode optical fibers, the single mode optical fibers having ends;
providing a second fiber ribbon cable comprising thermally expandable core (TEC) optical fibers, the TEC optical fibers having ends;
fusing the ends of the single mode fibers to the ends of respective TEC fibers using laser radiation; and
forming tapered core regions in the TEC fibers, proximate the ends of the TEC fibers, using laser radiation.

16. A method as recited in claim 15, further comprising producing the laser radiation using a carbon dioxide laser.

17. A method as recited in claim 16, wherein the ends of the TEC fibers fused to the ends of the single mode fibers are located at a first end of the second fiber ribbon cable and further comprising attaching ends of the TEC fibers at a second end of the second fiber ribbon cable to an alignment block.

18. A method as recited in claim 17, further comprising aligning the alignment block with an optical chip so that the unexpanded cores of the sections of TEC fibers are aligned with waveguides in the optical chip.
